(19) United States
(12) Patent Application Publication
(10) Pub. No.: US 2011/0122639 A1
(43) Pub. Date: May 26, 2011

(54) ADJUSTMENT SYSTEM FOR AT LEAST ONE LIGHT MODULE OF A LIGHTING APPARATUS OF A VEHICLE AND LIGHTING APPARATUS FOR VEHICLES

(75) Inventors: Heinz-Uwe Spork, Lippstadt (DE); Jürgen Schulte, Buren (DE); Hans-Gerd Hammelbeck, Lippstadt (DE); Katrin Hunecke, Lippstadt (DE)

(73) Assignee: HELLA KGaA HUECK & CO., Lippstadt (DE)

(21) Appl. No.: 12/950,109

(22) Filed: Nov. 19, 2010

(30) Foreign Application Priority Data
Nov. 25, 2009 (EP) 09 177 003.2

(51) Int. Cl. F21V 19/02

(52) U.S. Cl. 362/523

(57) ABSTRACT

The present invention relates to an adjustment system for at least one light module of a lighting apparatus of a vehicle, comprising a holding frame located in a housing of the lighting apparatus which holds the at least one light module, wherein the holding frame is installed such that it is able to pivot around an axis of rotation of the adjustment system inside the housing of the lighting apparatus, and further comprising an adjusting device for tilting the holding frame around the axis of rotation of the adjustment system, wherein the adjusting device and the holding frame are swivel-mounted to one another. The invention further relates to a lighting apparatus for a vehicle, comprising a housing, at least one light module inside the housing, and a corresponding adjustment system for the at least one light module.

### CROSS-REFERENCE TO RELATED APPLICATIONS

The present application claims priority to and incorporates herein by reference European Patent Application Serial No. 09 177 003.2 filed on Nov. 25, 2009

### BACKGROUND

Adjustment systems for lighting apparatuses such as headlamps are well-known from the prior art. They can be driven by hand or an electric motor. An adjustment system may be used to adjust the position of the emitted light such as the low beam of a vehicle in relation to the horizontal.

Lighting apparatuses such as headlamps of motor vehicles normally comprise a housing with at least one adjustable light module inside. The at least one light module is preferably mounted on a carrier frame that is able to move inside the housing. The mount may support rotary or pivoting movements of the carrier frame.

For example, DE 10 2004 058 200 A1 discloses a headlamp for vehicles comprising a plurality of light modules mounted on a carrier frame. An alignment mechanism allows the optical axes of the light modules to be adjusted. That is to say that the alignment mechanism allows the optical axes of all light modules to be tilted at once, considering that said optical axes of the light modules are parallel. When the headlamp is in its normal position, the adjustment axes of the alignment mechanism are parallel to the optical axes of the light modules. This arrangement of adjustment axes of the alignment mechanism in relation to the optical axes of the light modules requires comparatively much mounting space inside the headlamp housing, thus disallowing a compact design of a lighting apparatus such as a headlamp for vehicles. After adjusting the light module along the adjustment axis, i.e. vertically in relation to the carrier frame, the horizontal and vertical axes of the light module need to be readjusted several times in order to properly set the light center.

### SUMMARY OF THE INVENTION

The present invention creates an adjustment system for at least one light module of a lighting apparatus of a vehicle and to further create a very compact lighting apparatus for a vehicle. Particularly, the adjustment system should require as little space as possible in the lighting apparatus such that the lighting apparatus can be designed to also have a comparatively small footprint.

The present invention relates to an adjustment system for at least one light module of a lighting apparatus of a vehicle, comprising a holding frame located in a housing of the lighting apparatus and holding the at least one light module, wherein the holding frame is installed such that it is able to pivot around an axis of rotation of the adjustment system inside the housing of the lighting apparatus, further comprising an adjusting device for tilting the holding frame around the axis of rotation of the adjustment system, wherein the adjusting device and the holding frame are swivel-mounted to one another. The invention further relates to a lighting apparatus for a vehicle, comprising a housing, at least one light module inside the housing, and an adjustment system for the at least one light module.

Further attributes and details of the invention are disclosed in the dependent claims, the description and the drawings. The attributes and details of the adjustment system described do of course also apply to the lighting apparatus and vice versa such that all aspects of the invention disclosed mutually apply by way of reference.

According to the first aspect of the invention, an adjustment system for at least one light module of a lighting apparatus of a vehicle, may comprise a holding frame located in a housing of the lighting apparatus and holding the at least one light module, wherein the holding frame is installed such that it is able to pivot around an axis of rotation of the adjustment system inside the housing of the lighting apparatus, and further comprising an adjusting device for tilting the holding frame around the axis of rotation of the adjustment system, wherein the adjusting device and the holding frame are swivel-mounted to one another. The adjustment system is characterized in that the adjustment axis of the adjusting device is skewed in relation to the long axis of the axis of rotation and in that the at least one light module is located on the holding frame such that the optical axis of the at least one light module or a parallel projection of the optical axis of the at least one light module, the latter cutting across the long axis of the axis of rotation, tilts against the long axis of the axis of rotation at an angle between 10° and 89°.

Configuring the adjustment axis of the adjusting device in relation to the long axis of the axis of rotation of the adjustment system in the aforesaid manner and further configuring the optical axis of the at least one light module in relation to the long axis of the axis of rotation of the adjustment system supports a compact design of the adjustment system. Tilting the axis of rotation of the adjustment system against the optical axis of the at least one light module, wherein the holding frame is able to pivot inside the lighting apparatus around said axis of rotation of the adjustment system, creates space inside the lighting apparatus that the adjusting device of the adjustment system can be installed in a space-saving manner. This arrangement also maintains the possibility of adjusting the at least one light module or the optical axis thereof by altering the position of the holding frame. After adjusting the light module along the adjustment axis of the adjusting device, the horizontal and vertical axes of said light module no longer needs to be readjusted several times in order to properly set the light center.

An adjustment system of the aforementioned type differs from other adjustment systems in that its adjustment axis is not aligned to the direction of and parallel to the optical axis of the at least one light module but offset against the optical axis with reference to the tilt angle of the axis of rotation of the adjustment system and/or to the tilt angle of the holding frame. Tilting the holding frame by moving the adjusting device allows the optical axis of the at least one light module to be modified, particularly in vertical direction. Depending on the size of the lighting apparatus and the holding frame inside said lighting apparatus, the at least one light module and the long axis of the axis of rotation of the adjustment system and/or the holding frame can be installed at an angle between 10° and 89°. The size of the angle entirely depends on the space available in the lighting apparatus as well as on the tilt angle demanded for the optical axis of the at least one light module.

In the normal position of the at least one light module, the optical axis of said light module, which is also referred to as the light axis, is parallel to the direction of the vehicle, that is to say, to the vehicle's long axis. By not arranging the axis of rotation of the adjustment system perpendicularly to the long axis of the vehicle allows the dimensions of the adjustment system to be reduced, particularly by an appropriately skewed orientation of the adjustment axis of the adjusting device in relation to the axis of rotation or the long axis of the axis of rotation.

It is also possible to mount two or more light modules on the holding frame of the adjustment system such that all light modules or the optical axes of all light modules can be varied by means of the adjustment system.

The adjustment device of the adjustment system can be joined to the holding frame such that a parallel projection of the adjustment axis of the adjusting device cutting the long axis of the axis of rotation is perpendicular to the long axis of the axis of rotation. Thus, the adjustment axis is normal to the axis of rotation. That is to say that, whereas the angle between the adjustment axis and the long axis of the axis of rotation is 90°, the adjustment axis does not cut the long axis of the axis of rotation. This arrangement of the adjusting device or the adjustment axis of the adjusting device, and its threaded spindle in particular, warrants that the holding frame that the adjusting device is swivel-mounted to can be tilted steadily. In this arrangement, the adjustment axis of the adjusting device is not perpendicular to the holding frame but tilts towards it. This configuration of the adjusting device allows the adjustment system to be designed as a compact system requiring little space. An adjustment system of this kind therefore installs in comparatively small lighting apparatuses, particularly in headlamps of motor vehicles.

Due to the special configuration of the components of the adjustment system, i.e., due to the relative position of the axis of rotation and the adjustment axis of the adjusting device and due to the position of the axis of rotation and the adjustment axis in relation to the optical axis of the at least one light module, a particularly vertical movement of the at least one light module may be supported without provoking any horizontal movement of the at least one light module. To say the least, a horizontal movement of the at least one light module provoked by a vertical movement of the optical axis of the at least one light module can be reduced such that the horizontal movement of the optical axis of the at least one light module is almost entirely beyond noticeability.

The adjustment system can be designed such that the optical axis of the at least one light module or a parallel projection of said optical axis of the at least one light module cutting across the adjustment axis of the adjusting device tilts against the adjustment axis of the adjusting device at an angle β between 1° and 80°, specifically between 5° and 50°. Setting this angle to a value between 10° and 45°, and particularly to a value between 20° and 40°, has been found to be particularly advantageous. If the optical axis of the at least one light module or a parallel projection of said optical axis of the at least one light module on the adjustment axis of the adjusting device on the one hand and the adjustment axis of the adjusting device on the other are kept at an angle between 5° and 50°, and particularly between 20° and 40°, the adjusting device and, thus, the adjustment system can be assured to take up as little space as possible. This, in turn, allows small dimensions of the lighting apparatus that the adjustment system is installed in. Particularly at an angle between 20° and 40°, setting the adjusting device may vertically move the at least one light module without the at least one light module noticeably moving in horizontal direction.

Setting the adjusting device and, thus, the adjustment axis is the means of tilting the holding frame forwards or backwards. This will turn the holding frame around the long axis of the axis of rotation.

The angle α may have a value between 45° and 80°, particularly between 50° and 70°, and very specifically of 60°. This angle α defines by how much the optical axis of the at least one light module or the projection of said optical axis of the at least one light module onto the long axis of the axis of rotation tilts towards the long axis of the axis of rotation. That is to say, compared to the prior art where the axis of rotation of the holding frame is perpendicular to the direction of the vehicle, the axis of rotation of an adjustment system according to the invention is turned away from the direction of the vehicle preferably by between 20° and 40°, and specifically by 30°. The position of the axis of rotation or the position of the long axis of the axis of rotation of the adjustment system does not change in relation to the optical axis of the at least one light module as the holding frame tilts. Practical experience has shown that the at least one light module does not tilt sideways when the position of the holding frame is changed by the adjusting device, if an angle between 20° and 40°, and particularly of 30°, is maintained between the optical axis of the at least one light module or the parallel projection of said optical axis of the at least one light module onto the axis of rotation on the one hand and the axis of rotation on the other. Tilting sideways is particularly avoided if the adjusting device is joined to the holding frame such that a parallel projection of the adjustment axis of the adjusting device onto the long axis of the axis of rotation is perpendicular to the long axis of the axis of rotation.

There is a plurality of design options for the adjusting device for tilting the holding frame. Particularly, said adjusting device may be driven by hand or an electric motor. The adjustment system may provide for an adjusting device comprising a threaded spindle that will turn a rotary motion initiated by a drive unit into a translational motion. Moving the threaded spindle changes the angle by which the adjustment axis tilts towards the holding frame. The joint between the adjusting device, i.e. the threaded spindle, and the holding frame may be a ball-and-socket joint.

In another adjustment system for at least one light module of a lighting apparatus, the axis of rotation may be located on a first side of the holding frame and the adjusting device is swivel-mounted on a second side of the holding frame opposite to said first side. This configuration of the axis of rotation and the adjusting device of the adjustment system allows the adjusting device to reliably tilt the holding frame around the axis of rotation.

According to a second aspect of the invention, a lighting apparatus for a vehicle may comprise a housing, at least one light module inside the housing, and an adjustment system for the at least one light module, wherein the adjustment system is designed according to the first aspect of the invention.

A lighting apparatus for a vehicle, particularly for a motor vehicle, whose adjustment system for the at least one light module comprises a holding frame mounted in a housing of the lighting apparatus and holds the at least one light module, wherein the holding frame is mounted in the housing of the lighting apparatus such that it can pivot around an axis of rotation of the adjustment system, and whose said adjustment system further comprises an adjusting device for tilting the holding frame around the axis of rotation of said adjustment system, wherein the adjusting device is swivel-mounted to the holding frame, wherein the adjustment axis of the adjusting device is skewed in relation to the long axis of the axis of rotation, and wherein the at least one light module is mounted on the holding frame such that the optical axis of the at least one light module or a parallel projection thereof that cuts the long axis of the axis of rotation tilts away from the long axis of the axis of rotation at an angle (α) between 10° and 89°, can be designed in a particularly space-saving manner while providing a good adjustment or calibration of the at least one light module.

The lighting apparatus may be installed in the vehicle such that the optical axis, i.e. the light axis, of the at least one light module is perpendicular to the direction of the vehicle, i.e. perpendicular to the long axis of the vehicle. The axis of rotation of the adjustment system or the holding frame of the adjustment system may tilt by 20° to 40°, particularly by 30°, away from the direction of the vehicle and is installed in the lighting apparatus such that it can be moved, particularly swiveled. Due to this special orientation of the adjustment system in relation to the at least one light module or in relation to the optical axis of the at least one light module, the lighting can be designed with small outer dimensions.

The light module may comprise different types of light sources. For example, the light module may comprise one or a plurality of halogen light emitters. According to another preferred advancement, the lighting apparatus may be designed such that its at least one light module comprises at least one light emitting diode (LED). A light module may comprise a plurality of light emitting diodes. Every light module or the light emitting diodes of a light module may be construed as separate elements. Thus, there could be a possibility of separately adjusting or calibrating every light emitting diode in order to provide the various LED lighting functions or establish congruence of the light emitting diodes in overlapping areas.

The lighting apparatus may be a lamp of a vehicle, particularly a headlamp of a vehicle. However, the lighting apparatus may also be construed as the tail light of a vehicle. Particularly, the vehicle could be a passenger car.

In another embodiment, the horizontal adjustment of the adjustment system, particularly the horizontal adjustment of the at least one light module, may be independent of the vertical adjustment of the at least one light module. In order to provide a horizontal adjustment of the at least one light module, the adjustment system may comprise separate adjusting elements.

Further features and advantages of the present invention, as well as the structure and operation of various embodiments of the present invention, are described in detail below with reference to the accompanying drawings.

### BRIEF DESCRIPTION OF THE DRAWINGS

The figures attached hereto are taken to further explain the invention.

The following is shown:

FIG. 1 is a schematic and perspective view of an adjustment system comprising a light module mounted on the holding frame of the adjustment system;

FIG. 2 is a schematic lateral view of the adjustment system of FIG. 1;

FIG. 3 is a schematic front view of the adjustment system of FIG. 1;

FIG. 4 is an enlarged view of some of the adjustment system shown in FIG. 3.

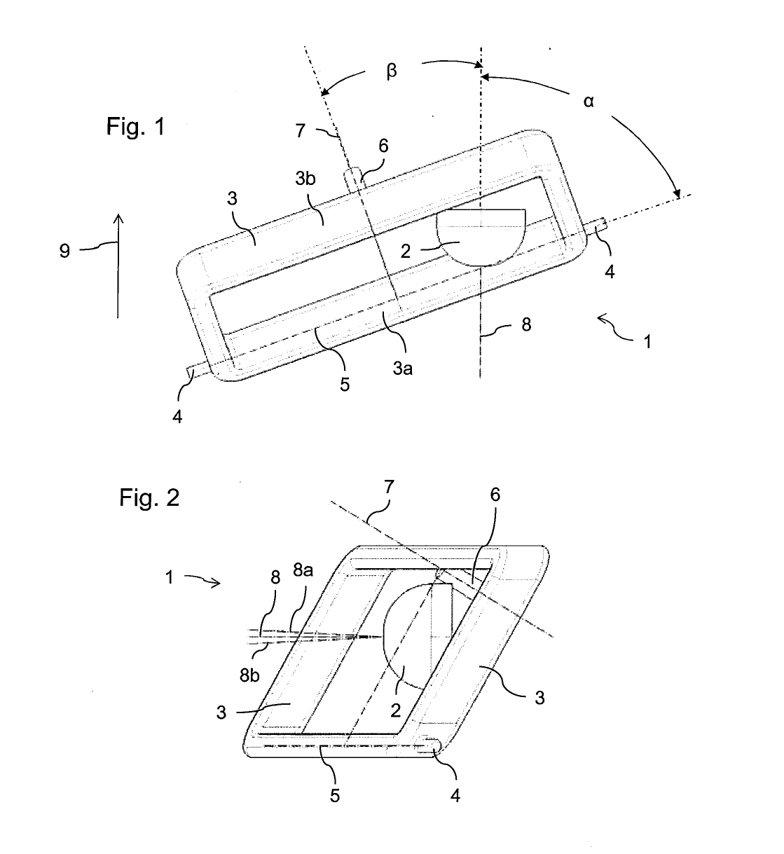

FIGS. 1 and 4 assign identical reference numbers to elements of the same function and mode of operation.

### DETAILED DESCRIPTION

FIG. 1 is a perspective view of a schematic illustration of an adjustment system 1 comprising a light module 2 mounted on the holding frame 3 of the adjustment system 1. The light module 2 preferably comprises at least one light emitting diode and is mounted on the holding frame 3. The adjustment system 1 comprises an axis of rotation 4 that the holding frame 4 is associated to. The axis of rotation 4 is swivel-mounted in the a lighting apparatus, particularly in the housing of a headlamp. That is to say, the holding frame 3 is able to swivel around the long axis 5 of the axis of rotation 4. In order to turn or tilt the holding frame 3, the adjustment system 1 comprises an adjusting device 6. The axis of rotation 4 is preferably mounted on a first side 3a of the holding frame 3, whereas the adjusting device 6 is preferably swivel-mounted on a second side 3b opposite the first side 3a of the holding frame 3. The adjustment axis 7 of the adjusting device 6 is skewed in relation to the long axis 5 of the axis of rotation 4. The light module 2 is mounted on the holding frame 3 such that the optical axis 8 of the light module 2 or a parallel projection of said optical axis 8 of said light module 2 on the axis of rotation 4 tilts against the long axis 5 of the axis of rotation 4 at an angle α. The angle α is preferably between 10° and 89° and particularly between 50° and 70°. Tilting the axis of rotation 4 against the optical axis 8 of the light module 2 or against the parallel projection of said optical axis 8 of said light module 2 onto the axis of rotation 4 and having the adjusting device 6 or the adjustment axis 7 of the adjusting device 6 maintain an angle of 1° to 80° and preferably between 20° to 40° in relation to the optical axis 8 of the light module 2 or the parallel projection of said optical axis 8 of said light module 2 onto the adjustment axis 7 of the adjusting device 6 is an appropriate means of saving on the space required to install the adjustment system 1 in a lighting apparatus, particularly in a headlamp, of a vehicle such as a passenger car. In a preferred embodiment of the adjustment system 1, the adjustment device 6 is joined to the holding frame 3 such that the parallel projection of the adjustment axis 7 of the adjusting device 6 cutting the long axis 5 of the axis of rotation 4 is perpendicular to the long axis 5 of the axis of rotation 4. This allows the adjusting device 6 to particularly easily and reliably tilt the holding frame 3 by turning said holding frame 3 around the axis of rotation 4 of the adjustment system 1.

FIG. 2 is a schematic lateral view of an adjustment system 1. Said FIG. 2 illustrates how the optical axis 8 of the light module 2 changes when the holding frame 3 tilts. The optical axis referenced as number 8 in FIG. 2 represents the normal position of the light module 2. When the adjusting device 6 tilts up holding frame 3, the optical axis of the light module 2 moves to the position referenced as number 8b. When the adjusting device 6 tilts down holding frame 3, the optical axis of the light module 2 follows suit to the position referenced as number 8a. The adjustment axis 7 of the adjusting device 6 is skewed in relation to the long axis 5 of the axis of rotation 4 of the adjustment system 1. FIG. 2 again clearly illustrates that, in a parallel projection of the adjustment axis 7 onto the axis of rotation 4, the adjustment axis 7 is perpendicular to the long axis 5 of the axis of rotation 4. Since the axis of rotation 4 of the adjustment system is skewed in relation to the parallel projection of the optical axis 8 onto the axis of rotation 4, the adjustment axis 7 also corresponds to the tilt angle of the axis of rotation 4 or the holding frame 3 and offset against the optical axis. This saves on the space required to install the adjustment system 1 in a lighting apparatus such as a headlamp.

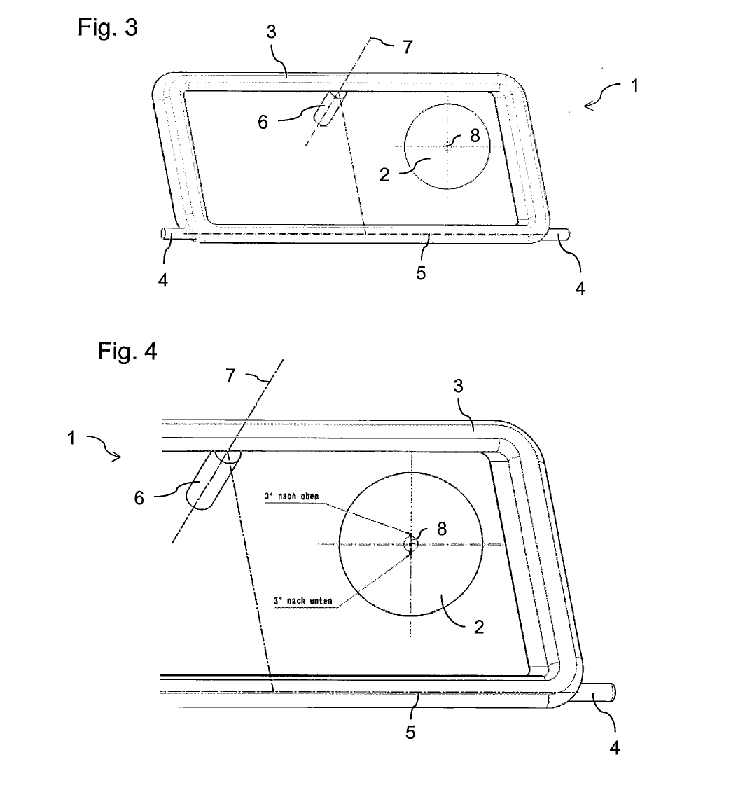

FIG. 3 and FIG. 4 are schematic front views of the adjustment system of FIG. 1 with FIG. 4 being an enlarged view of FIG. 3. The optical axis 8 of the light module 2 is perpendicular to the sheet that FIG. 3 and FIG. 4 are drawn on. As opposed to the prior art, the adjustment axis 7 of the adjusting device 6 is not parallel but skewed to and tilted against the optical axis 8 of the light module 2. FIG. 4 illustrates how the mid-point of the light module 2 vertically moves up by 3° or down by 3° when the adjusting device 6 modifies the tilt angle of the holding frame 3. Despite the tilted and skewed position of the adjustment axis 7 in relation to the optical axis 8 of the light module 2, the adjusting device 7 mainly tilts said optical axis 8 of said light module 2 in vertical direction. Setting the angle β between the adjustment axis 7 and the optical axis 8 or the parallel projection of said optical axis 8 onto said adjustment axis 7 to a value between 20° and 40° particularly enables the adjustment system 1 to reduce the horizontal shift of the light module 2 to a negligible quantity.

In view of the foregoing, it will be seen that several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

### REFERENCE ITEMS

1 adjustment system
2 light module
3 carrier frame
3a first side of the carrier frame
3b second side of the carrier frame
4 axis of rotation
5 long axis of the axis of rotation
6 adjusting device
7 adjustment axis of the adjusting device
8 optical axis/light axis
9 direction of the vehicle

We claim:

1. An adjustment system for at least one light module of a lighting apparatus of a vehicle, comprising:
a holding frame located in a housing of the lighting apparatus and holding the at least one light module;
the holding frame being installed such that it is able to pivot around an axis of rotation of the adjustment system inside the housing of the lighting apparatus;
an adjusting device for tilting the holding frame around the axis of rotation of the adjustment system, wherein the adjusting device and the holding frame are swivel-mounted to one another;
the axis of adjustment of the adjusting device being skewed in relation to the long axis of the axis of rotation;
the at least one light module being located on the holding frame such that at least one of the optical axis of the at least one light module or a parallel projection of the optical axis of the at least one light module, tilts against the long axis of the axis of rotation at an angle (α) between about 10° and about 89°.

2. The adjustment system of claim 1, further comprising the adjusting device being joined to the holding frame such that the axis of adjustment of the adjusting device, through a parallel projection cutting across the long axis of the axis of rotation, is perpendicular to the long axis of the axis of rotation.

3. The adjustment system of claim 1 further comprising the optical axis of the at least one light module or a parallel projection of said optical axis of the at least one light module cutting across the axis of adjustment of the adjusting device tilts against the axis of adjustment of the adjusting device at an angle (β) between about 1° and about 80°.

4. The adjustment system of claim 1 further comprising the angle (α) ranging between about 45° and about 80° and/or that the angle (β) ranges between about 10° and about 45°.

5. The adjustment system of claim 1, further comprising the adjusting device having a threaded spindle for turning a rotary motion into a translational motion.

6. The adjustment system of claim 4, further comprising the axis of rotation running along a first side of the holding frame and the adjusting device being swivel-mounted to a second side of the holding frame, said second side being opposite to the first side of the holding frame.

7. A lighting apparatus for a vehicle, comprising:
a housing;
at least one light module inside the housing; and
an adjustment system for the at least one light module, the adjustment system comprising;
a holding frame located in the housing of the lighting apparatus and holding the at least one light module;
the holding frame being installed such that it is able to pivot around an axis of rotation of the adjustment system inside the housing of the lighting apparatus;
the adjusting device being configured to tilt the holding frame around the axis of rotation of the adjustment system, wherein the adjusting device and the holding frame are swivel-mounted to one another;
the axis of adjustment of the adjusting device being skewed in relation to the long axis of the axis of rotation;
the at least one light module being located on the holding frame such that at least one of the optical axis of the at least one light module or a parallel projection of the optical axis of the at least one light module, tilts against the long axis of the axis of rotation at an angle (α) between about 10° and about 89°.

8. The lighting apparatus of claim 7, further comprising the at least one light module comprising at least one light emitting diode.

9. The lighting apparatus of claim 7, further comprising the lighting apparatus is a headlamp of a vehicle, said headlamp being located at the front of said vehicle.

10. The lighting apparatus of claim 7, further comprising the axis of rotation of the holding frame of the adjustment system being swivel-mounted inside the housing of the lighting apparatus such that it tilts against the long axis of the vehicle at an angle between about 5° and about 45°.

11. The adjustment system of claim 1 wherein the parallel projection of the optical axis of the at least one light module cuts across the long axis of the axis of rotation.

12. The adjustment system of claim 3 wherein the angle (β) is between about 5° and about 50°.

13. The adjustment system of claim 4 wherein the angle (α) is between about 50° and about 70°.

14. The adjustment system of claim 4 wherein the angle (α) is about 60°.

15. The adjustment system of claim 4 wherein the angle (β) is between about 20° and about 40°.

16. The lighting apparatus of claim 10 wherein said angle is between about 20° and about 40°.

17. The lighting apparatus of claim 10 wherein said angle is about 30°.
